(19) United States
(12) Patent Application Publication
(10) Pub. No.: US 2009/0168094 A1
(43) Pub. Date: Jul. 2, 2009

(54) Recording control device, recording control method, and program

(75) Inventors: Yukiharu Horiuchi, Chino-shi (JP); Yasuhiro Takeuchi, Sakaki-Machi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/317,102

(22) Filed: Dec. 19, 2008

(30) Foreign Application Priority Data
Dec. 27, 2007 (JP) 2007-337512

(51) Int. Cl. G06F 3/12

(52) U.S. Cl. 358/1.15

(57) ABSTRACT

A printer driver for controlling a recording device enables easily and accurately configuring functions of a recording device that functions that are difficult to configure. When information specifying whether the transportation means of the printer 3 advances the recording medium between pages during the recording operation, and information specifying whether the roll paper 100 is cut between pages is input, the host computer 1 that controls the printer 3 displays a selection display unit that enables selecting configuration candidates indicating different combinations of whether or not the pages are advanced between pages and whether or not the paper is cut between pages on the display 1a, and when a configuration candidate is selected in the selection display unit, displays an image that graphically depicts the relative positions of the image recorded on the page, the margin formed by advancing the medium between pages, and where the paper is to be cut.

### BACKGROUND OF THE INVENTION

1. Field of Invention

The present invention relates to a recording control device and a recording control method for controlling a recording device that records images, and to a program for achieving the recording control device and method.

2. Description of Related Art

A computer typically runs a program called a printer driver in order for the computer to control a printer that is connected to the computer. See, for example, Japanese Unexamined Patent Appl. Pub. JP-A-H08-244279. The printer driver enables configuring the printing conditions and functions of the printer.

As printers have become increasingly multifunctional, however, the parameters that can be set by the printer driver have become increasingly complex. This requires the operator to carefully confirm that the wrong settings are not set when using the printer driver to configure printer operation.

### SUMMARY OF THE INVENTION

The present invention enables using the printer driver that controls the recording device to easily and accurately configure the functions of a recording device that has complicated functions.

A first aspect of the invention is a recording control device for controlling a recording device having a transportation unit that conveys a recording medium, a recording unit that records images on the recording medium, and a cutting unit that cuts the recording medium. The recording control device includes an input unit that enables inputting information specifying whether or not to advance the recording medium between pages by means of the transportation unit, and whether or not to cut the recording medium between pages by means of the cutting unit; a setting unit that configures operation of the recording device based on the information input by means of the input unit; a recording control unit that causes the recording device to operate according to the operation set by the setting unit; and a display control unit that presents in a display screen a selection display unit enabling selecting configuration candidates showing combinations of conveying and not conveying the recording medium between pages and cutting or not cutting the recording medium between pages when there is input from the input unit, and when a configuration candidate is selected from the selection display unit by the input unit, displays an image showing the relative positions of the images recorded on the pages, the margin formed by conveyance between pages, and the cutting position determined by the selected configuration candidate.

When inputting whether the recording device advances the recording medium between pages by means of the transportation means, and whether to cut the recording medium between pages by means of the cutting means, this aspect of the invention presents on the display screen a selection display unit enabling selecting configuration candidates representing different combinations of advancing or not advancing the recording medium between pages and cutting or not cutting the recording medium between pages, and the printer can be easily desirably configured by selecting the appropriate configuration candidate displayed in the selection display unit. In addition, because an image showing the relationship between image recorded on the page, the margins formed by advancing the recording medium between pages, and the cutting positions is displayed on the display screen according to the selected configuration candidate when a configuration candidate is selected from the selection display unit, how the recording device will operate when that configuration candidate is selected can be clearly displayed graphically when selecting a configuration candidate. Because settings are saved after confirming the content of the selected setting, configuration errors can be reliably prevented, and wasted recording medium and work effort resulting from configuration errors can be eliminated.

When setting whether or not to feed the paper between pages and whether or not to cut the paper between pages, an incorrect setting can result in errors that cannot be ignored, such as cutting journal reports and other forms that should not be cut, adding margins unnecessarily as a result of unnecessarily advancing the paper between pages, or not adding a margin where required. In such situations the operator that makes these settings must proceed cautiously. However, because the invention displays an image depicting how the recording device will operate as a result of the selected setting, the user can confirm the operation of the recording device from the displayed image, and can easily configure the recording device without error. Furthermore, because incorrect settings can be reliably prevented by means of a simple operation, configuring the recording device applies less stress on the operator, the recording device can be configured without excessive effort, and operating efficiency can be improved.

Preferably, the recording control unit records images on the recording medium for each job containing one or a plurality of pages by means of the recording device. Further preferably, the input unit enables inputting information specifying whether or not to advance the recording medium between jobs by means of the transportation unit, and whether or not to cut the recording medium between jobs by means of the cutting unit, in addition to whether or not to advance the recording medium between pages by means of the transportation unit, and whether or not to cut the recording medium between pages by means of the cutting unit. Further preferably, the display control unit enables selecting configuration candidates indicating combinations of conveying or not conveying the recording medium between jobs, cutting or not cutting the recording medium between jobs, conveying or not conveying the recording medium between pages, and cutting or not cutting the recording medium between pages in the selection display unit when there is input from the input unit, and when a configuration candidate is selected, displays an image showing the relationship between the image recorded on each page included in a job, the margins formed by conveying the recording medium between pages, the margins formed by conveying the recording medium between jobs, and the cutting positions based on the selected configuration candidate. Further preferably, the display control unit displays an image depicting the relative positions.

When the recording device records images by jobs each containing one or a plurality of pages, configuring the recording device to advance or not advance the recording medium between jobs and cut or not cut the recording medium between jobs can be set easily and without error in addition to setting the recording device to advance or not advance the recording medium between pages and cut or not cut the recording medium between pages.

More particularly, complex settings involving numerous factors, such as whether or not to advance the recording medium between jobs, whether or not to cut the recording medium between jobs, whether or not to advance the recording medium between pages, and whether or not to cut the recording medium between the pages, can be set by selecting the appropriate configuration candidate. In addition, because an image visually representing the operation of the recording device when a particular configuration candidate is selected is displayed, complex settings can be easily configured without error, and the work load on the operator can be greatly reduced.

Further preferably, the input unit enables inputting information specifying the recording direction of images on the recording medium and the type of recording medium, and the display control unit displays for selection only the configuration candidates corresponding to the image recording direction and recording medium type set in the selection display unit when the image recording direction and recording medium type are set in the input unit.

When the image recording direction on the recording medium and type of recording medium are set, only the configuration candidates that are appropriate to these settings can be selected in the selection display unit. A configuration that is not compatible with the image recording direction and the type of recording medium therefore cannot be set, and configuration errors can be reliably prevented.

Further preferably, the display control unit changes and displays an image corresponding to the configuration candidate when a configuration candidate is selected in the selection display unit and a different configuration candidate is then selected by the input unit, and the setting unit saves the information denoting the selected configuration candidate when a configuration candidate in the selection display unit is selected and then confirmed by the input unit.

In this aspect of the invention, because an image corresponding to the selected configuration candidate is displayed when a configuration candidate is selected in the selection display unit, and a different image corresponding to the newly selected configuration candidate is displayed if a different configuration candidate is then selected, configuration candidates displayed in the selection display unit can be selected at will to find the desired setting while confirming the operation of the recording device from the displayed image, and can therefore easily configure the settings as desired without error. Furthermore, because the information indicated by the selected configuration candidate is set when a configuration candidate is selected by the input means from the selection display unit and the selection is then confirmed, the user can freely change the selected configuration candidate in the selection display unit until the selection is confirmed, operability is improved and the burden on the operator can be further reduced.

Another aspect of the invention is a recording control method for controlling a recording device having a transportation means that conveys a recording medium, a recording means that records images on the recording medium, and a cutting means that cuts the recording medium perpendicularly to the transportation direction, the recording control method including steps of: displaying in a display screen for selection and input configuration candidates showing combinations of conveying and not conveying the recording medium between pages and cutting or not cutting the recording medium between pages when information specifying whether or not to advance the recording medium between pages by means of the transportation means, and whether or not to cut the recording medium between pages by means of the cutting means, is input, and displaying an image showing the relative positions of the images recorded on the pages, the margin formed by conveyance between pages, and the cutting position determined by the selected configuration candidate; and setting the operation of the recording device based on the input information and causing the recording device to operate according to the set operation.

When inputting information specifying whether or not the transportation means of the recording device advances the recording medium between pages, and whether or not the cutting means cuts the recording medium between pages, this aspect of the invention selectably displays configuration candidates indicating particular combinations of advancing or not advancing the recording medium between pages and cutting or not cutting the recording medium between pages on the selection display unit, and enables easily inputting a particular configuration by simply selecting the configuration candidate displayed in the selection display unit. In addition, because an image visually depicting the relative positions of the image recorded on each page, the margin formed by advancing the recording medium between pages, and the cutting position is displayed according to the selected configuration candidate when a configuration candidate is selected in the selection display unit, the operation of the recording device can be visually confirmed when a configuration candidate is selected, and configurations can be easily set without error.

Preferably, the recording control method also has steps of: recording images on the recording medium for each job containing one or a plurality of pages by means of the recording device; enabling inputting information specifying whether or not to advance the recording medium between jobs by means of the transportation means, and whether or not to cut the recording medium between jobs by means of the cutting means, in addition to whether or not to advance the recording medium between pages by means of the transportation means, and whether or not to cut the recording medium between pages by means of the cutting means; displaying in the display means for selection and input configuration candidates indicating combinations of conveying or not conveying the recording medium between jobs, cutting or not cutting the recording medium between jobs, conveying or not conveying the recording medium between pages, and cutting or not cutting the recording medium between pages when there is input; and when a configuration candidate is selected, displaying an image showing the relationship between the image recorded on each page included in a job, the margins formed by conveying the recording medium between pages, the margins formed by conveying the recording medium between jobs, and the cutting positions based on the selected configuration candidate.

Preferably, information specifying the recording direction of images on the recording medium and the type of recording medium can be input, and displaying in the display means for selection only the configuration candidates corresponding to the image recording direction and recording medium type that are set when a configuration is set.

Further preferably, the image corresponding to the configuration candidate is changed and displayed when a configuration candidate is selected in the display means and a different configuration candidate is then selected, and the information denoting the selected configuration candidate is saved when a configuration candidate is selected and then confirmed.

Another aspect of the invention is a program that can be executed by a computer for controlling a recording device having a transportation means that conveys a recording medium, a recording means that records images on the recording medium, and a cutting means that cuts the recording medium, the program causing the computer to operate as: an input means that enables inputting information specifying whether or not to advance the recording medium between pages by means of the transportation means, and whether or not to cut the recording medium between pages by means of the cutting means; a setting means that configures operation of the recording device based on the information input by means of the input means; a recording control means that causes the recording device to operate according to the operation set by the setting means; and a display control means that selectably presents in a display screen configuration candidates showing combinations of conveying and not conveying the recording medium between pages and cutting or not cutting the recording medium between pages when there is input from the input means, and when a configuration candidate is selected by the input means, displays an image showing the relative positions of the images recorded on the pages, the margin formed by conveyance between pages, and the cutting position determined by the selected configuration candidate.

By running this program on a computer, configuration candidates representing different combinations of advancing or not advancing the recording medium between pages and cutting or not cutting the recording medium between pages are selectably displayed in a selection display unit when inputting information specifying whether the recording device advances the recording medium between pages by means of the transportation means, and whether the recording medium is cut between pages by means of the cutting means, and the recording device can be easily and desirably configured by selecting the appropriate configuration candidate displayed in the selection display unit. Furthermore, because an image showing the relationship between the images recorded on the pages, the margins formed by advancing the recording medium between pages, and the cutting positions is displayed on the display screen according to the selected configuration candidate when a configuration candidate is selected from the selection display unit, how the recording device will operate when that configuration is selected can be confirmed from the image displayed when a configuration candidate is selected, and the recording device can be easily configured without error.

This control program may be recorded on any computer-readable medium, including magnetic recording media such as floppy disks and hard disk drives, magneto-optical media such as MO discs, CD-R, CD-RW, DVD±R, DVD±RW, DVD-RAM, and other optical recording media, and storage devices using semiconductor memory.

The invention enables configuring settings by means of the simple operation of selecting setting candidates displayed on a display screen, and enables configuring the settings easily without error by viewing images visually representing the operation of the recording device resulting from the printer settings.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 shows the basic configuration of the host computer in a preferred embodiment of the invention.

FIG. 2 is a block diagram showing the configuration of the host computer and the printer.

FIG. 3 is a function block diagram showing a configuration enabled by the printer driver.

FIG. 4 illustrates specific examples of different paper feed modes.

FIG. 5 illustrates specific examples of different paper feed modes.

FIG. 6 shows a sample parameter setting screen presented on the display screen.

FIG. 7 shows another example of the parameter setting screen presented on the display screen.

FIG. 8 shows examples of the graphics used to represent each paper feed mode.

FIG. 9 shows other examples of the graphics used to represent each paper feed mode.

FIG. 10 is a flow chart describing the operation of the host computer.

FIG. 11 is a flow chart describing another operation of the host computer.

### DESCRIPTION OF PREFERRED EMBODIMENTS

A preferred embodiment of the present invention is described below with reference to the accompanying figures.

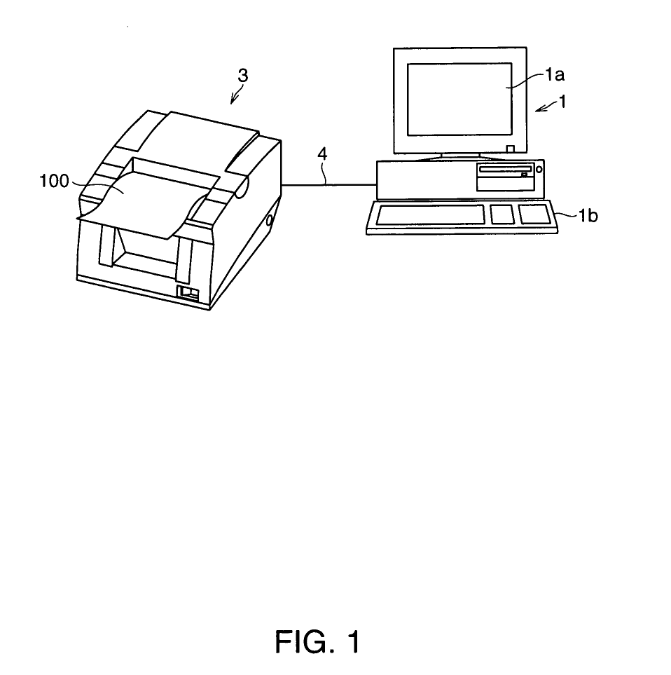

FIG. 1 shows the basic configuration of a host computer 1 according to this embodiment of the invention.

The host computer 1 (recording control device) is connected to a printer 3 (recording device) through a cable 4. The printer 3 is a thermal printer that uses roll paper 100 such as thermal paper wound in a roll as the recording medium and records text and images on the printing surface of the roll paper 100 by means of a thermal print head.

As further described below, the printer 3 has an internal paper cutter mechanism for cutting the roll paper 100 horizontally across the paper width.

The host computer 1 sends print job data including image data and control data through the cable 4 to the printer 3, and thus controls the printer 3 to print images on the roll paper 100. The host computer 1 is a computer having a display 1a (display screen) for displaying images and video, and an input device such as a keyboard 1b that is operated by the operator.

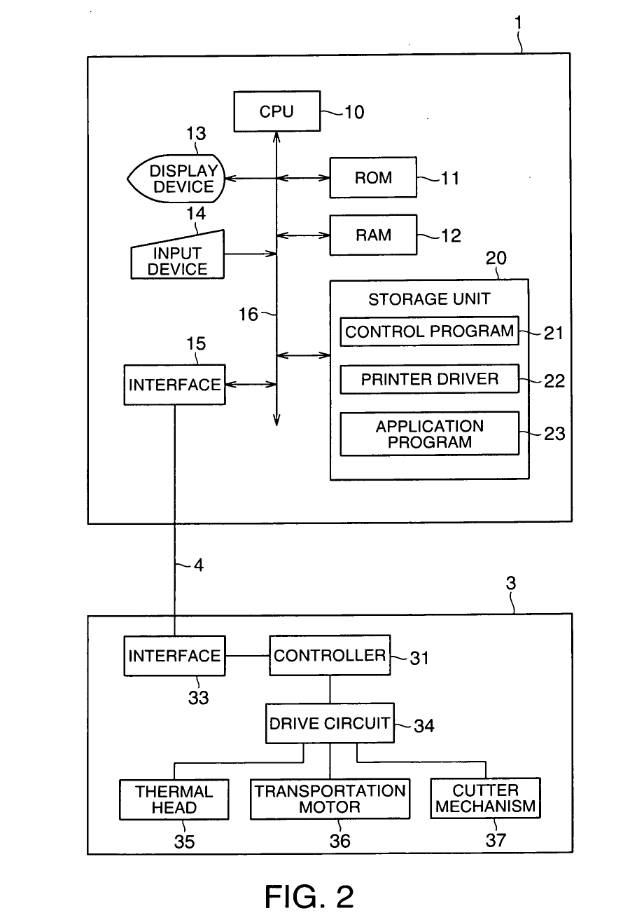

FIG. 2 is a block diagram showing the configuration of the host computer 1 and the printer 3.

The host computer 1 includes a CPU 10 (central processing unit) that controls the host computer 1 and the printer 3 by running appropriate programs, ROM 11 (read-only memory) for storing the basic control program that is run by the CPU 10, RAM 12 (random access memory) for temporarily storing programs executed by the CPU 10 and processed data, a display device 13 for displaying images on the display 1a (FIG. 1), an input device 14 (input means) that includes a mouse or keyboard 1b (FIG. 1), for example, and detects input resulting from operation of the input device, an interface 15 to which the printer 3 is connected through the cable 4, a storage unit 20 for storing data and programs, and a bus 16 connecting these other components.

The CPU 10 reads the basic control program stored in ROM 11 into working memory in RAM 12 and runs the program to control the different parts of the host computer 1. The CPU 10 also reads and executes the control program 21 and application program 23 described below from the storage unit 20 to implement the various functions of the host computer 1. The CPU 10 also functions as the parameter setting means, recording control means, and display control means of the invention by reading and executing the printer driver 22 from the storage unit 20, setting the operating parameters of the printer 3, and controlling the printer 3 according to these settings.

ROM 11 is a nonvolatile storage device for storing data such as the basic control program executed by the CPU 10. RAM 12 is rendered using volatile memory devices, and is used as working memory by the CPU 10.

The storage unit 20 stores the programs and data in a storage area rendered by a magnetic, optical, or other type recording medium, or by a semiconductor device. For example, the storage unit 20 stores the control program 21 for initializing the different parts of the host computer 1 and controlling the host computer 1 in response to requests from the application program 23, the printer driver 22 (corresponding to the program of the accompanying claims) for controlling the printer 3, and an application program 23 enabling the host computer 1 to implement specific functions.

The display device 13 presents different display screens on the display 1a, which is a CRT or liquid crystal display, for example, as controlled by the CPU 10. The input device 14 includes an input device such as a keyboard 1b, mouse, tablet, or touch panel that is disposed on top of the display 1a, interprets operating signals input from the input device, and outputs the input content to the CPU 10.

The interface 15 enables communication with the printer 3 through the cable 4 as controlled by the interface 15. More specifically, the interface 15 sends print job data gated by the CPU 10 as described below through the cable 4 to the printer 3.

The printer 3 includes a controller 31 that controls the other parts of the printer 3, an interface 33 for communicating through the cable 4 as controlled by the controller 31, and a drive circuit 34 that drives the thermal head 35 (recording means), transportation motor 36 (transportation means), and cutter mechanism 37 (cutting means) as controlled by the controller 31.

The thermal head 35 connected to the drive circuit 34 is a print head that has a plurality of heating elements and prints images on the roll paper 100 by selectively heating the heating elements in contact with the roll paper 100 (FIG. 1). The drive circuit 34 causes the heating elements to heat at the required time by energizing the appropriate heating elements of the thermal head 35 as controlled by the controller 31.

The transportation motor 36 includes a transportation motor (not shown in the figure) such as a stepping motor, and transportation roller (not shown in the figure) that is driven rotationally by the transportation motor. Note that the transportation roller may also function as a platen that is disposed opposite the thermal head 35 so that the roll paper 100 is conveyed between the thermal head 35 and the transportation roller. The number of transportation rollers is also not limited. The drive circuit 34 causes the transportation motor 36 to turn at the necessary timing by outputting drive current and drive pulses to the transportation motor 36 as controlled by the controller 31.

The cutter mechanism 37 is disposed to the transportation path through which the roll paper 100 travels after images are recorded by the thermal head 35, and includes a cutter (not shown in the figure) that cuts across the width of the roll paper 100, and a cutter drive unit (not shown in the figure) that drives the cutter. Disposed facing each other from opposite sides of the roll paper 100 transportation path, the cutter includes, for example, a fixed knife and one or a plurality of movable knives that are driven by the cutter drive unit to meet the fixed knife. By appropriately adjusting how far the movable knife is driven, the cutter can be set to cut completely across the roll paper or to leave a portion at an edge or the middle of the roll paper uncut. The drive circuit 34 energizes the cutter drive unit (not shown in the figure) as controlled by the controller 31 to move the movable knife the required amount at the required time.

The interface 33 communicates with the host computer 1 as controlled by the controller 31, and receives and outputs print job data sent from the host computer 1 to the controller 31.

The controller 31 interprets the print job data received through the interface 33, and converts the image data to be printed on the roll paper 100 into internal memory. The controller 31 extracts the control data specifying the printing conditions for printing and the operations before and after printing from the received print job data, and operates according to this control data. The control data configures different operations and parameters, including the print margins and print density, whether to feed the paper to insert a margin between pages (page border), whether the cutter mechanism 37 cuts the roll paper 100 between pages, whether to feed the paper to insert a margin between jobs, and whether the cutter mechanism 37 cuts the roll paper 100 between jobs.

The controller 31 controls the drive circuit 34 according to the control data and image data, operates the transportation motor 36 and cutter mechanism 37 to execute the operation specified by the control data, and drives the thermal head 35 to print according to the image data written to internal memory. The printer 3 thus prints and outputs images to roll paper 100 as controlled by the host computer 1.

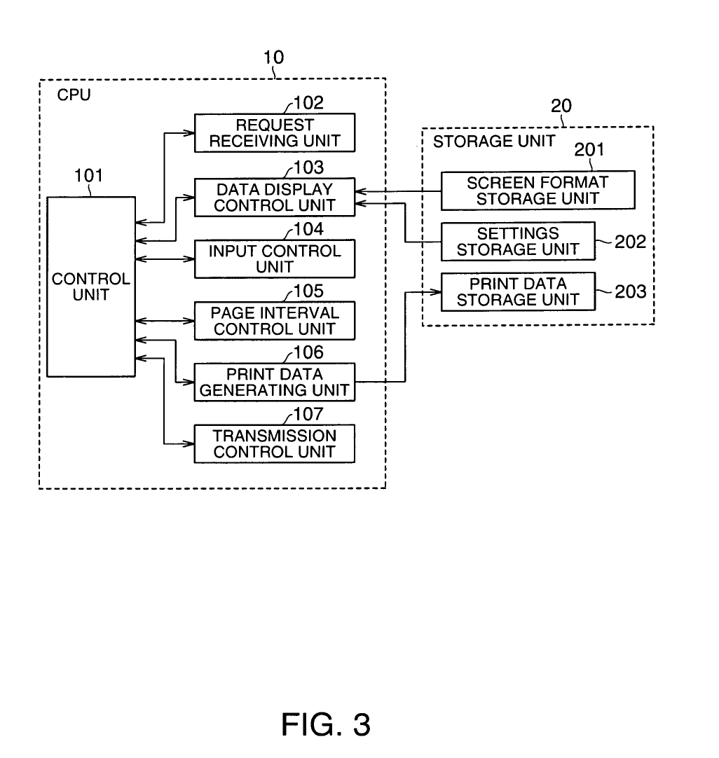

FIG. 3 is a function block diagram showing the configuration of functions implemented by the host computer 1 (FIG. 2) when running the printer driver 22 (FIG. 2). The function blocks shown in FIG. 3 are realized virtually by the CPU 10 and storage unit 20. The configuration shown in FIG. 3 corresponds to the recording control device of the invention.

The CPU 10 includes a request receiving unit 102, a data display control unit 103 (display control means, data control means), an input control unit 104, a page interval control unit 105 (setting means), a print data generating unit 106, a transmission control unit 107, and a control unit 101 that controls these other parts.

The request receiving unit 102 receives print requests from the application program 23 (FIG. 2) for the printer 3 together with the document to be printed.

The data display control unit 103 displays information relating to the settings of the printer 3 for the document to be printed received by the request receiving unit 102 in a window on the display device 13 based on the window format stored in the screen format storage unit 201 of the storage unit 20 and the settings stored in settings storage unit 202.

When desired information relating to the settings of the printer 3 displayed by the data display control unit 103 is selected or input by operation of the input device 14, the input control unit 104 receives the input. Parameters relating to the paper feed mode and the paper orientation can be set by operating the input device 14 in this embodiment of the invention.

The page interval control unit 105 determines whether the paper feed mode, which is one of the printer 3 configuration settings, is set to the page margin mode conveying the paper to produce a margin between pages, or the page cutting mode in which the roll paper 100 (FIG. 1) is cut between pages.

The print data generating unit 106 generates the image data that is actually printed on the roll paper 100 when printing a print document, control data according to the paper transportation or cutting operations determined by the page interval control unit 105, and print job data for sending the image data and control data together to the printer 3 as a print job. The print job data is stored in the print data storage unit 203 of the storage unit 20.

The transmission control unit 107 sends the print job data generated by the print data generating unit 106 together with a print request command requesting execution of the print job to the printer 3. Note that the print job data may alternatively function as the print request command.

The print data generating unit 106 and transmission control unit 107 operate as a recording control means, and the printer 3 operates as configured according to the job data created and sent by them.

The control unit 101 controls the request receiving unit 102, data display control unit 103, input control unit 104, page interval control unit 105, print data generating unit 106, and transmission control unit 107 to operate cooperatively with each other.

When the printer driver 22 executes, the storage unit 20 functions as the screen format storage unit 201, settings storage unit 202, and print data storage unit 203. As described above, the screen format storage unit 201 is the memory area that stores the screen format data for displaying the printing configuration screen, for example, in the display area of the display device 13 by means of the data display control unit 103. The settings storage unit 202 is the area storing settings relating to the operation of the printer 3 that are set based on input from the input control unit 104. The print data storage unit 203 stores the print job data generated by the print data generating unit 106.

The paper feed modes that can be set in this embodiment of the invention are described next.

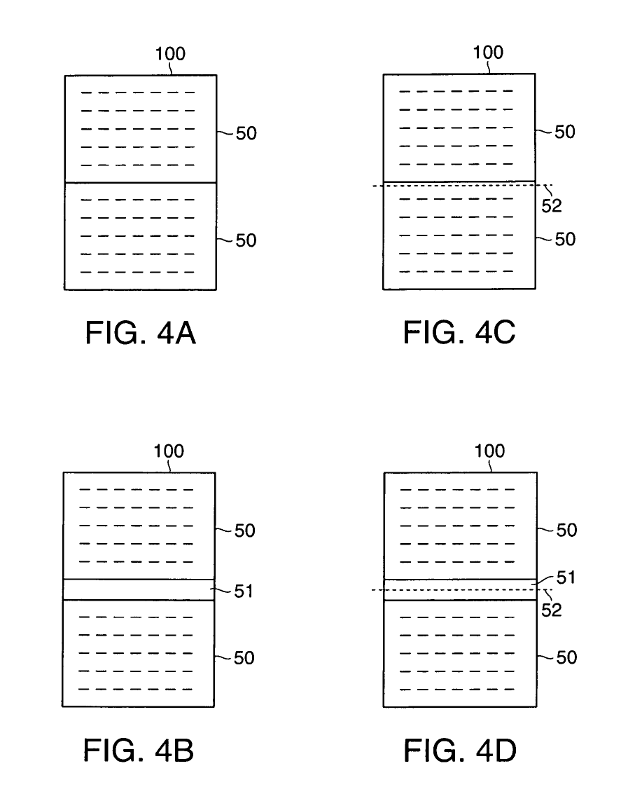

FIG. 4 shows specific examples of the paper feed modes, FIG. 4A illustrating operation when the paper is not fed or cut between pages, FIG. 4B showing feeding the paper but not cutting between pages, FIG. 4C showing cutting without feeding between pages, and FIG. 4D showing both feeding and cutting between pages. FIG. 4A to FIG. 4D show straight lines indicating the ends of the pages for understanding, but whether the printer 3 actually prints such lines can be set as desired.

When the paper is not fed or cut between pages as shown in FIG. 4A and the printer 3 prints a plurality of pages consecutively, the roll paper 100 is discharged from the printer 3 with the printed parts 50 where the individual page images are printed connected to each other. Only the margins that are set within each page appear at the end of each page, and no additional margin is added between pages.

If the printer 3 prints a plurality of pages consecutively while advancing the paper between pages as shown in the paper feed mode in FIG. 4B, a margin 51 is inserted between the pages on the roll paper 100. In this case the printer 3 discharges the roll paper 100 as a continuous web with an additional margin inserted between adjacent pages.

If the paper is cut without advancing the paper between pages as shown in FIG. 4C and the printer 3 prints a plurality of pages consecutively, the printed parts 50 of each page are connected with no margin outside the page boundary, and a cutting position 52 is set between the pages. The printer 3 then causes the cutter mechanism 37 (FIG. 2) to operate at the cutting position 52 to cut across the width of the roll paper 100. Because there is no margin between the pages, the cutting position 52 is positioned substantially at the page boundary, that is, the end of the page. However, because of the tolerance between the fixed knife (not shown in the figure) and movable knife (not shown in the figure) of the cutter mechanism 37, the tolerance in the timing of cutter mechanism 37 operation, and the cutting width when the cutter mechanism 37 cuts the roll paper 100, the cutting position 52 may deviate from the page end or a part of each page may be lost from cutting. If such deviations are not allowed, an extra margin may be added in the printed part 50 of each page or a margin 51 may be set as shown in FIG. 4D. In the example shown in FIG. 4C the paper is cut by the printer 3 at the printed part 50 of each page and the individual pages are discharged.

When the paper is advanced and cut between pages as shown in FIG. 4D and the printer 3 prints a plurality of pages consecutively, a margin 51 is formed between each page on the roll paper 100 and the cutting position 52 is set in this margin 51. In the example shown in FIG. 4D, the printed part 50 of each page is cut to a slightly larger size including the margin 51, and the pages are discharged one at a time from the printer 3.

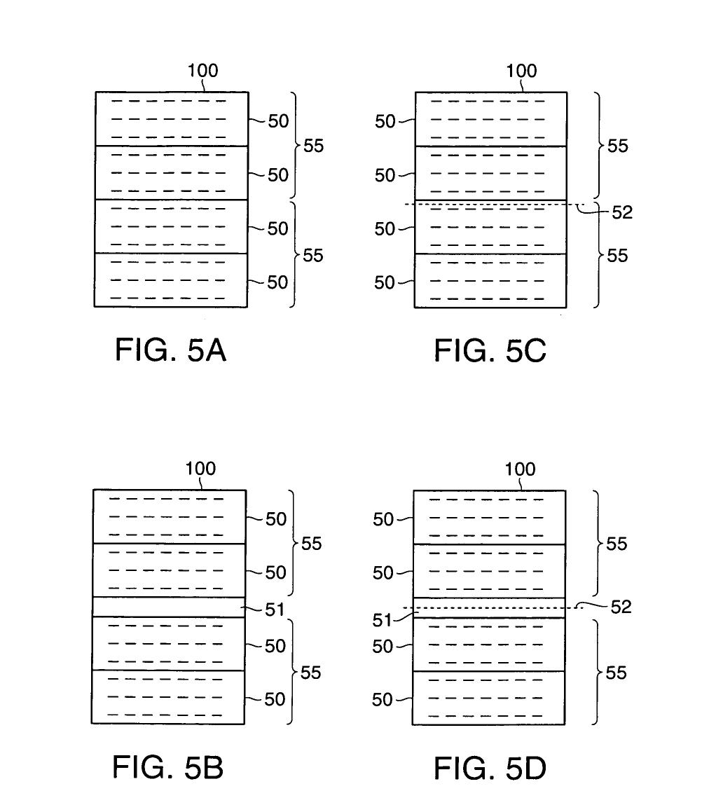

FIG. 5 illustrates operation in the paper feed mode executed when the printer 3 consecutively prints a plurality of print jobs each containing a plurality of pages. FIG. 5A illustrates operation when the paper is not fed or cut between jobs, FIG. 5B shows feeding the paper but not cutting between jobs, FIG. 5C shows cutting without feeding between jobs, and FIG. 5D shows both feeding and cutting between jobs. FIG. 5A to FIG. 5D show straight lines indicating the ends of the pages and jobs for understanding, but whether the printer 3 actually prints such lines can be set as desired.

In the example shown in FIG. 5A, the printer 3 prints the printed part 55 of one job and then prints the printed part 55 of the next job with feeding or cutting the paper between jobs. As a result, the roll paper 100 is discharged from the printer 3 with the printed parts 55 of a plurality of jobs connected to each other.

Because the printer 3 advances the roll paper 100 a predetermined distance after printing one job, a margin 51 is formed at the end of each job in the example shown in FIG. 5B. When the next job is then printed, a margin 51 is formed between the printed part 55 of each job. In this case the printer 3 discharges the roll paper 100 web with a margin 51 inserted between successive jobs.

In the example shown in FIG. 5C, the paper is cut without being advanced between jobs. More specifically, when the printer 3 consecutively prints a plurality of jobs, the jobs are printed continuously so that a margin outside the page area is not created between the printed part 55 of each job, the cutting position 52 is set between jobs, and the printer 3 operates the cutter mechanism 37 (FIG. 2) at the cutting position 52 to cut across the width of the roll paper 100. The printed roll paper 100 is thus cut from the unprinted roll after each job. Because a margin outside the page area is not set between jobs in this situation, the cutting position 52 is directly on or offset from the break between each job.

In the example shown in FIG. 5D, a margin 51 is formed between jobs when the printer 3 consecutively prints a plurality of jobs, the cutting position 52 is set in this margin 51, and the roll paper 100 is cut by the cutter mechanism 37 at this cutting position 52. In this example the printed part 50 of each job is cut to a slightly larger size including the margin 51 and discharged.

In the examples shown in FIG. 5A to FIG. 5D the paper is not advanced or cut between the pages of a single job, but in actual use the operations of advancing and cutting the paper between pages as shown in FIG. 4A to FIG. 4D, and the operations of advancing and cutting the paper between jobs as shown in FIG. 5A to FIG. 5D, may be combined as desired.

The host computer 1 can thus control the printer 3 to operate in 16 different paper feed modes, for example, by variously combining the operation of advancing the paper between printed pages to form a margin between pages, the operation of cutting the roll paper 100 between pages, the operation of advancing the paper to form a margin between jobs when a plurality of print jobs are printed consecutively, and the operation of cutting the roll paper 100 between jobs.

The paper feed mode can_be configured by accessing the printer driver 22 (FIG. 2) on the host computer 1 and displaying a configuration screen on the display 1a.

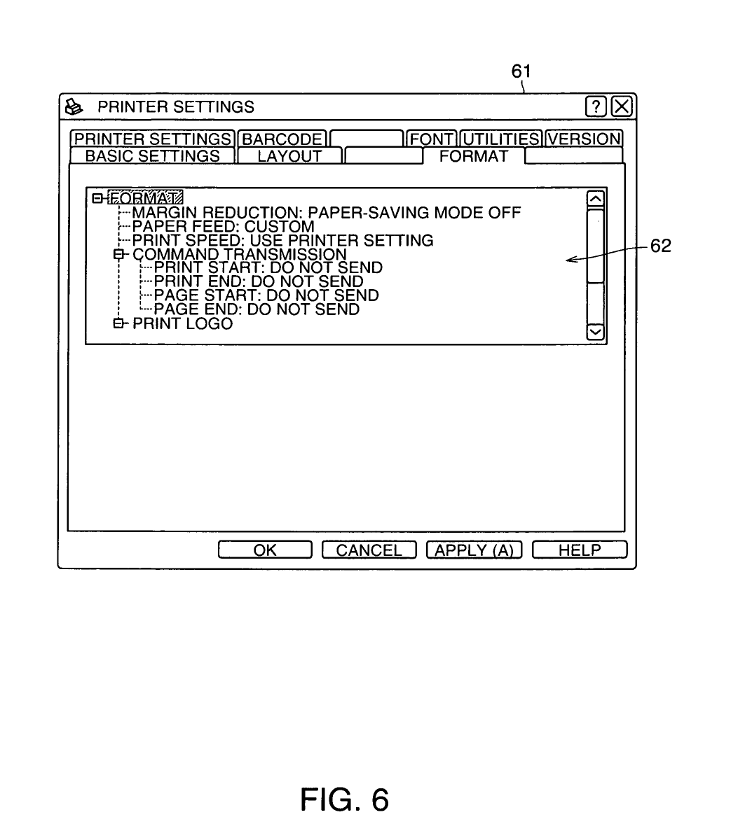

FIG. 6 shows an example of a configuration window 61 displayed on the display 1a.

The configuration window 61 shown in FIG. 6 is displayed as a graphical user interface (GUI) on the display 1a. The configuration window 61 includes a parameter selection area 62 enabling selecting a parameter (setting) to configure from among a plurality of selectable parameters.

Items that can be selected by operating the keyboard 1b or other part of the input device 14, and the value currently set for each item, are displayed in the parameter selection area 62. When this parameter selection area 62 is displayed and PAPER FEED is selected for configuration, a window for configuring the paper feed mode is displayed.

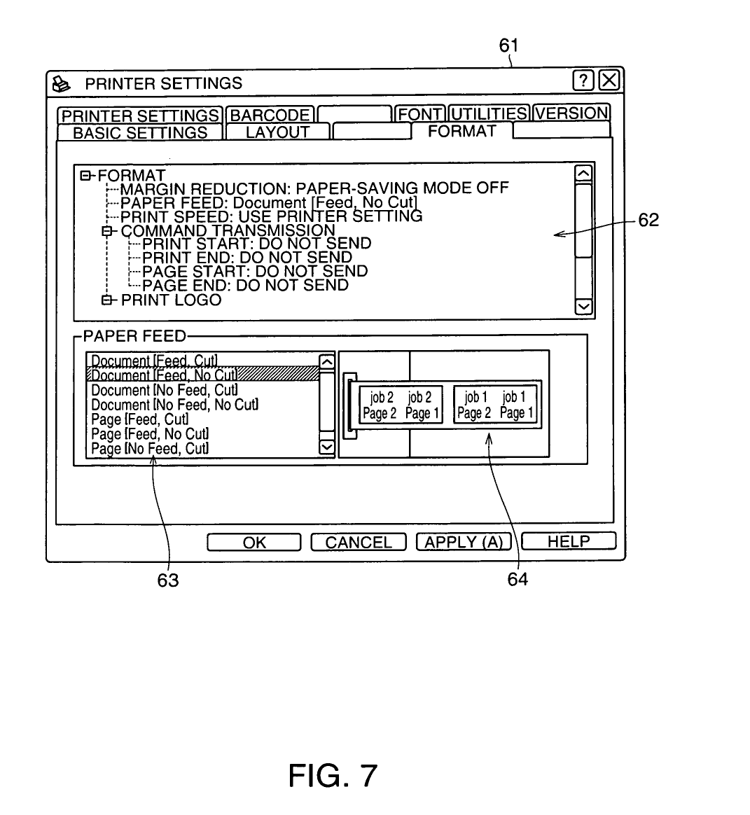

FIG. 7 shows another example of the configuration window 61, and particularly shows a configuration window 61 that is displayed to configure the paper feed mode.

A paper feed mode display unit 63 (selection display unit) for selecting the paper feed mode is displayed in the configuration window 61 in FIG. 7. Candidates of the paper feed modes that can be selected are displayed in the paper feed mode display unit 63 according to the type of printer 3 and the paper that can be used in the printer 3. The input device 14 can be operated to select the desired paper feed mode from among the candidates displayed in the paper feed mode display unit 63.

When one paper feed mode is selected in the paper feed mode display unit 63, a paper feed mode graphic 64 (corresponding to an “image” in the accompanying claims) corresponding to the selected paper feed mode is displayed in the configuration window 61. The paper feed mode graphics 64 graphically illustrate the image printed on each page in the selected paper feed mode, whether the paper is advanced between pages and between jobs, and whether the paper is cut between pages and between jobs. When one paper feed mode is selected from the paper feed mode display unit 63 using the input device 14; an image corresponding to the selected paper feed mode is displayed as the paper feed mode graphic 64. When a different paper feed mode candidate is then selected in the paper feed mode display unit 63, the paper feed mode graphic 64 is changed to an image corresponding to the newly selected paper feed mode. The operator of the host computer 1 can therefore easily select and set the suitable paper feed mode by selecting the paper feed mode in the paper feed mode display unit 63 while viewing the paper feed mode graphic 64 graphically representing the paper feed mode.

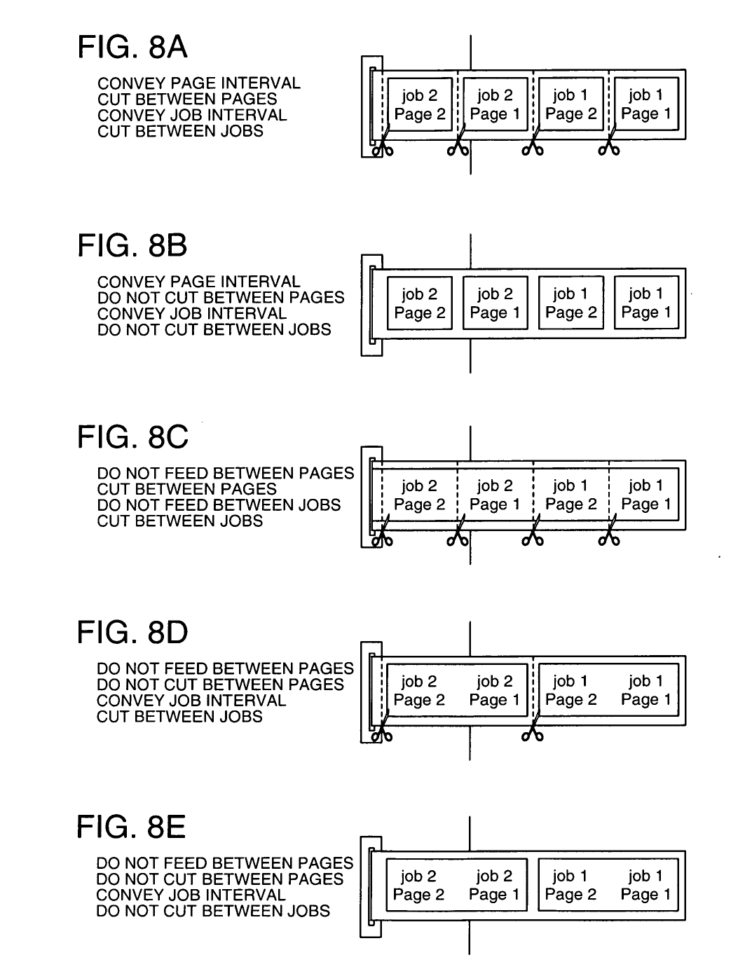

FIG. 8 shows examples of the graphics that are displayed as the paper feed mode graphic 64 in FIG. 7.

In the sample graphics shown in FIG. 8A to FIG. 8E, two jobs each containing two pages are printed consecutively, the jobs are identified as Job1 and Job2, and the positions of the images printed as the pages of each job are indicated as Job1 Page1, Job1 Page2, Job2 Page1, and Job2 Page2.

In the graphics for paper feed modes in which the paper is cut between pages or between jobs, the cutting position is denoted by a dotted line with a scissors icon showing that the dotted line is where the paper will be cut. The margin formed by advancing the paper is also shown in the graphics for paper feed modes that advance the paper between pages or between jobs.

FIG. 8A shows a graphic for a paper feed mode in which the paper is advanced and cut between pages and between jobs. It is thus obvious from the graphic that a margin is formed between the pages of each job and between each job, and the paper is cut in the margin.

FIG. 8B shows a graphic for a paper feed mode in which the paper is advanced between pages and between jobs but is not cut. It is thus obvious from the graphic that a margin is formed between the pages of each job and between each job, and that the paper is not cut.

FIG. 8C shows a graphic for a paper feed mode in which the paper is cut but is not advanced between pages and between jobs. It is thus obvious from the graphic that the paper is cut between each page and between each job without inserting a margin outside of the page area.

FIG. 8D shows a graphic for a paper feed mode in which the paper is not advanced or cut between pages, but is advanced and cut between jobs. It is thus obvious from the graphic that a margin is not inserted outside of the page area and the paper is not cut between the pages of each job, but a margin outside of the page area is inserted between jobs and the paper is cut in this margin.

FIG. 8E shows a graphic for a paper feed mode in which the paper is not advanced between pages, the paper is advanced to insert a margin between jobs, and the paper is not cut between pages or between jobs. It is thus obvious from the graphic that a margin outside of the page area is not inserted between the pages of each print job, a margin outside of the page area is inserted between jobs, and the paper is not cut.

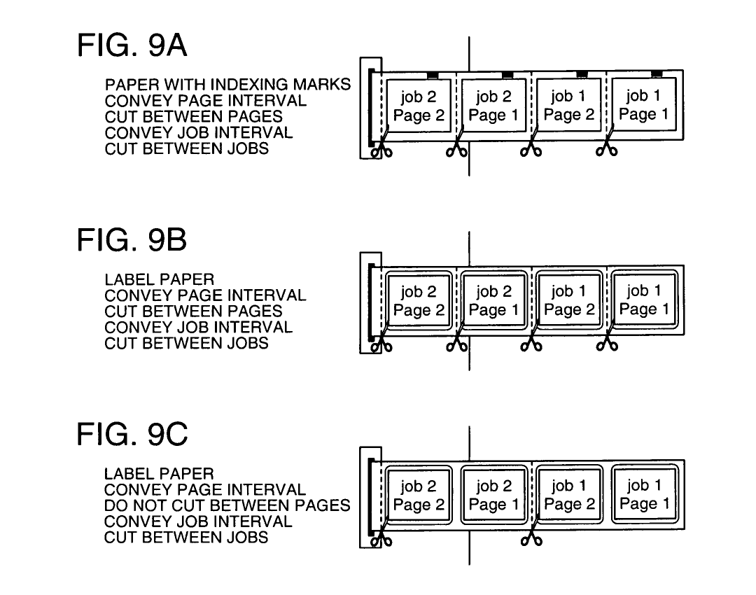

Similarly to FIG. 8, FIG. 9 shows examples of graphics that are displayed as the paper feed mode graphic 64. As in FIG. 8A to FIG. 8E, in the graphics shown in FIG. 9A to FIG. 9C, two jobs each containing two pages are printed consecutively, the jobs are identified as Job1 and Job2, and the positions of the images printed as the pages of each job are indicated as Job1 Page1, Job1 Page2, Job2 Page1, and Job2 Page2.

In the graphics for paper feed modes in which the paper is cut between pages or between jobs, the cutting position is denoted by a dotted line with a scissors icon showing that the dotted line is where the paper will be cut. The margin formed by advancing the paper is also shown in the graphics for paper feed modes that advance the paper between pages or between jobs.

FIG. 9A is an example of the graphic corresponding to a paper feed mode that can be selected when roll paper 100 with index marks is used. In this example it is obvious that the paper is advanced and cut between pages and between jobs, and the relative positions of the index marks on the roll paper 100 and the page images, the margins between pages and between jobs, and the cutting positions are clearly shown.

FIG. 9B is an example of a graphic corresponding to a paper feed mode that can be selected when label paper is used as the roll paper 100. In this example the graphic makes it obvious that the paper is advanced and cut both between pages and between jobs. This graphic also makes it obvious that the labels are cut off one by one in this paper feed mode.

FIG. 9C is an example of a graphic corresponding to a paper feed mode that can be selected when label paper is used as the roll paper 100, the paper is advanced both between pages and between jobs, and the paper is cut only between jobs. In this paper feed mode the plural labels included in one print job are separated from the label paper roll while remaining connected on the common web liner. This graphic makes it obvious that plural labels are cut from the roll in batches.

The host computer 1 thus displays in the configuration window 61 graphics illustrating the paper feed modes that can be selected according to the type of paper used as well as how the paper is advanced and cut in the selected paper feed mode.

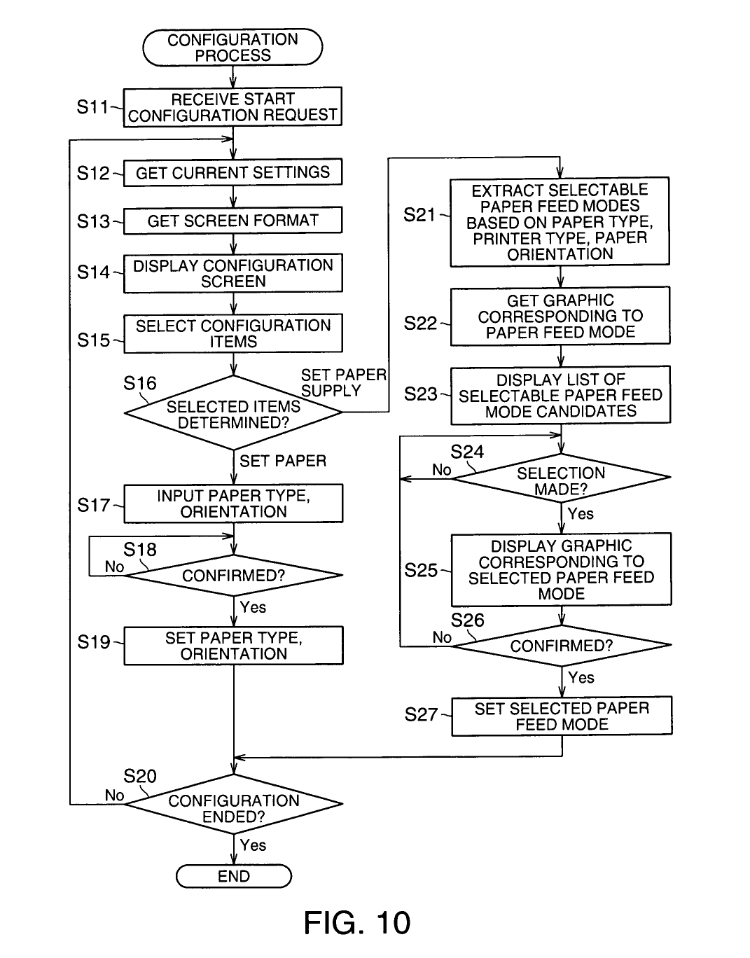

FIG. 10 is a flow chart of the operation of the host computer 1 when executing the printer driver 22, and relates particularly to the operation related to the configuration settings.

When a start configuration request is asserted by operation of the input device 14 (step S11), the CPU 10 functioning as the data display control unit 103 acquires the current configuration settings stored in the settings storage unit 202 (step S12), acquires the screen format stored in the screen format storage unit 201 (step S13), and then displays the configuration screen on the display 1a (step S14). An example of the configuration screen displayed here is the configuration window 61 shown by way of example in FIG. 6.

Functioning as the input control unit 104, the CPU 10 then detects input from the input device 14 while the configuration screen is displayed, and when an operation selecting a configuration setting is detected (step S15) determines what setting was selected (step S16).

If the selected setting is a paper setting, the CPU 10 acquires the type of paper and the paper orientation that are input by operating the input device 14 (step S17). When the settings are confirmed (step S18 returns Yes), the acquired paper type and orientation are stored by the settings storage unit 202 as the configuration setting (step S19) and control then goes to step S20. The paper orientation as used here indicates the printing direction in which images are printed on the roll paper 100, and enables selecting whether the page images are printed in a portrait orientation with the top and bottom of the images aligned with the transportation direction of the roll paper 100, or in a landscape orientation with the top and bottom of the images aligned across the width of the roll paper 100.

In step S20 the CPU 10 determines whether configuring the settings is completed, terminates this process if an input operation completing the settings is detected by the input device 14, and returns to step S12 if the configuration process continues.

If the setting selected in step S15 is not a paper setting and is not a paper feed setting (paper feed mode setting), the CPU 10 executes the process corresponding to the selected item and then proceeds to step S20.

If the configuration setting selected in step S15 is a paper feed setting, the CPU 10 functions as the data display control unit 103 and input control unit 104 and based upon the paper type, paper orientation, and printer 3 type settings acquired from the settings storage unit 202 extracts the paper feed modes that can be selected from among all paper feed modes that can be configured by the printer driver 22 (step S21).

The CPU 10 then functions as the data display control unit 103 and acquires the graphic (such as one of the paper feed mode graphics 64 shown in FIG. 8A to FIG. 8E and FIG. 9A to FIG. 9C) corresponding to the paper feed modes extracted in step S21 (step S22).

Functioning as the data display control unit 103, the CPU 10 then displays a list of the paper feed modes extracted in step S21 as the selectable paper feed modes (step S23), and then waits for a selection to be made through the input device 14 (step S24).

When an operation selecting a paper feed mode is detected by the input device 14 (step S24 returns Yes), the CPU 10 functioning as the input control unit 104 identifies the paper feed mode selected by this operation, and functioning as the data display control unit 103 displays the graphic corresponding to the identified paper feed mode (step S25).

After a paper feed mode is thus selected and the setting is confirmed (step S26 returns Yes), the CPU 10 stores the selected paper feed mode in the settings storage unit 202 (step S27) and goes to step S20.

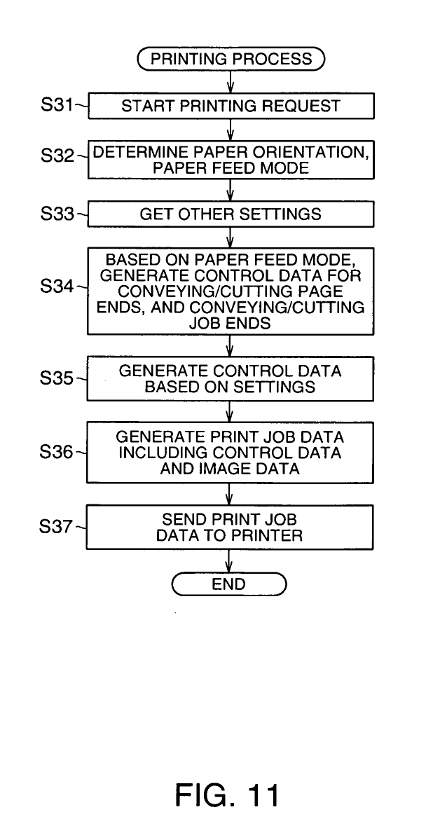

FIG. 11 is a flow chart describing an operation of the host computer 1 when executing the printer driver 22, and more particularly shows the operation relating to executing the printing process.

When a print request is asserted by the executing application program 23, the CPU 10 functioning as the request receiving unit 102 receives the request (step S31). Functioning as the data display control unit 103, the CPU 10 then acquires the settings stored in the settings storage unit 202, determines the paper orientation and paper feed mode (step S32), and acquires other necessary settings (step S33).

Functioning as the page interval control unit 105, the CPU 10 generates control data for advancing and cutting the paper between pages and advancing and cutting the paper between jobs based on the paper feed mode (step S34), and generates other control data based on other settings (step S35). Functioning as the print data generating unit 106, the CPU 10 then generates the print job data including this control data and the image data to be printed on the roll paper 100 (step S36), saves the print job data in the print data storage unit 203 and sends the print job data to the printer 3 by means of the transmission control unit 107 function (step S37). This process then ends.

As described above, the host computer 1 according to this embodiment of the invention executes the printer driver 22 to present a paper feed mode display unit 63 on the display 1a when configuring whether the printer 3 advances the paper between pages by means of the transportation motor 36 or cuts the roll paper 100 between pages by means of the cutter mechanism 37 during the printing process. This paper feed mode display unit 63 enables the user to select paper feed mode candidates including various combinations of advancing or not advancing the paper between pages and cutting or not cutting the paper between pages, and enables easily configuring the printer by the user selecting one of the paper feed modes displayed in the paper feed mode display unit 63.

In addition, because an image visually indicating the relationship between the page image printed on each page, the margin formed by advancing the paper between pages, and the paper cutting position determined by the selected paper feed mode is displayed as a corresponding paper feed mode graphic 64 when a paper feed mode is selected in the paper feed mode display unit 63, how the printer 3 operates when a particular paper feed mode is selected is clearly visually displayed when the paper feed mode is selected. Because the content of a selected setting can be visually confirmed when a setting is selected, incorrect settings can be reliably prevented, and wasted effort and roll paper 100 due to incorrect settings can be prevented.

When setting whether or not to feed the paper between pages and whether or not to cut the paper between pages, an incorrect setting can result in errors that cannot be ignored, such as cutting journal reports and other forms that should not be cut, adding margins unnecessarily as a result of unnecessarily advancing the paper between pages, or not adding a margin where required. In such situations the operator that uses the host computer 1 to make these settings must proceed cautiously. With the embodiment of the invention described above, however, the user can confirm the printer 3 operation resulting from the selected settings by looking at a paper feed mode graphic 64 depicting the operation, and incorrect settings can thus be easily prevented. Furthermore, because incorrect settings can be reliably prevented by means of a simple operation, configuring the printer applies less stress on the operator, the printer can be configured without excessive effort, and operating efficiency can be improved.

When the host computer 1 sends to the printer 3 data for print jobs containing one or a plurality of pages and the printer 3 prints page images job by job, the invention enables easily setting without error whether or not to advance the paper and whether or not to cut the paper between jobs in addition to setting whether or not to advance the paper and whether or not to cut the paper between the pages in each job. More particularly, complex settings involving numerous factors, such as whether or not to advance the paper between jobs, whether or not to cut the paper between jobs, whether or not to advance the paper between pages, and whether or not to cut the paper between the pages, can be set by selecting the paper feed mode. In addition, because a paper feed mode graphic 64 visually representing the operation of the printer 3 when a particular paper feed mode is selected is displayed, complex settings can be easily configured without error, and the work load on the operator can be greatly reduced.

Furthermore, when the paper orientation and type of roll paper 100 are set, the host computer 1 enables selecting in the paper feed mode display unit 63 only the paper feed mode candidates that are appropriate to these settings, thus preventing selecting a setting that is inapplicable to the paper orientation and type of roll paper 100, and reliably preventing configuration errors.

In addition, when a paper feed mode candidate is selected from the paper feed mode display unit 63, a paper feed mode graphic 64 corresponding to the selected paper feed mode candidate is displayed, and if a different paper feed mode candidate is then selected, a different paper feed mode graphic 64 corresponding to the newly selected paper feed mode candidate is displayed. The paper feed modes shown in the paper feed mode display unit 63 can therefore be freely selected while visually confirming the printer 3 operation and thus finding and selecting the desired setting easily without error.

Furthermore, because a configuration is set after a paper feed mode is selected in the selection display unit and then confirmed, paper feed mode candidates can be freely selected and the corresponding graphic can be seen in the paper feed mode display unit 63 until the selection is confirmed. This further improves operability and thus further reduces the burden on the user.

As described above, by executing the printer driver 22 the host computer 1 enables configuring printer settings by means of the simple operation of selecting paper feed mode candidates displayed on a display 1a. In addition, the user can easily select the desired setting without error by viewing an image visually representing the printer 3 operation resulting from a selected setting.

The host computer 1 and printer 3 are directly connected to communicate with each other over a cable 4 in the embodiment described above, but the invention is not so limited. The host computer 1 and printer 3 may, for example, be connected to a network (such as a LAN), and the host computer 1 may control and print to the printer 3 over the network. Further alternatively, the interface 15 of the host computer 1 and the interface 33 of the printer 3 may be wireless communication interfaces.

The foregoing embodiment is described as setting whether to cut the roll paper 100 between pages and between jobs by means of the cutter mechanism 37, but it is obviously also possible for the cutter mechanism 37 to cut the roll paper 100 at a desired location unrelated to the foregoing settings.

In addition, when a printer driver 22 that is compatible with only a particular type of printer 3 is executed by the host computer 1, setting the printer 3 type by means of the printer driver 22 may be omitted.

When the printer 3 is compatible with only a particular type of roll paper 100, setting the type of roll paper 100 may also be omitted.

Furthermore, the means of indicating the position of the image recorded on the page in relation to the margin formed by advancing the paper between pages and the cutting position is a visual graphic displayed on screen in the foregoing embodiment, but the invention is not so limited and a buzzer, voice announcement, or other means may be used instead.

The printer driver 22 that is executed by the CPU 10 in the foregoing embodiment is stored in advance to the storage unit 20, but the printer driver 22 may be stored to a magnetic disk, optical disc, memory card, or other type of recording medium, and the printer driver 22 may then be read by the host computer 1 from the recording medium and installed. Further alternatively, the host computer 1 may download and install the printer driver 22 through a communication interface from the Internet, a LAN, or other network.

The printer 3 is described in the foregoing as a thermal printer that records images on thermal roll paper 100, but the printer 3 may be any type of printer that can record images according to commands sent from the host computer 1, and may use any type of recording method.

More specifically, the printer 3 may be a so-called thermal transfer printer that uses plain paper or other sheet medium that does not produce color (referred to as simply plain paper herein) instead of roll paper 100 as the recording medium, sets an ink ribbon carrying ink that melts when heat is applied in contact with the sheet medium, and applies heat energy to this ink ribbon to record images. The invention may also be applied to other types of printers such as a dye sublimation printer that uses plain paper and fuses ink to the sheet by heating the ink, an inkjet printer that discharges a liquid or gel ink onto a sheet medium to record images, a laser printer that exposes a photoconductor to a laser beam, forms a latent toner image on the photoconductor, and transfers this image to the sheet medium, a dot impact printer that transfers ink to the sheet medium by placing an ink ribbon carrying ink against the sheet and then striking or applying pressure to the ink ribbon, and a printer that forms images by applying heat or pressure to sheet media coated with color formation capsules.

Yet further, the invention can be applied to printers that are built into various types of electronic devices, and printers that function as hybrid devices integrated with other types of electronic devices.

The host computer 1 that controls the printer 3 is also not limited to a personal computer, and may be rendered as a personal digital assistant (PDA) or by the computer of a device that is integrated with the printer 3 being controlled. By rendering a display screen corresponding to the display 1a and an input device corresponding to the input device 14 in the main device containing the printer 3 being controlled, and executing the printer driver 22, the settings can be configured using the input device while viewing images displayed on the screen of the main device.

It will also be obvious that the detailed configuration of the mechanism for conveying the roll paper 100 and other mechanisms in the printer 3 may be changed as desired.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A recording control device for controlling a recording device having
a transportation unit that conveys a recording medium,
a recording unit that records images on the recording medium, and
a cutting unit that cuts the recording medium,
the recording control device comprising:
an input unit that enables inputting information specifying whether or not to advance the recording medium between pages by means of the transportation unit, and whether or not to cut the recording medium between pages by means of the cutting unit;
a setting unit that configures operation of the recording device based on the information input by means of the input unit;
a recording control unit that causes the recording device to operate according to the operation set by the setting unit; and
a display control unit that presents in a display screen a selection display unit enabling selecting configuration candidates showing combinations of conveying and not conveying the recording medium between pages and cutting or not cutting the recording medium between pages when there is input from the input unit, and
when a configuration candidate is selected from the selection display unit by the input unit, displays an image showing the relative positions of the images recorded on the pages, the margin formed by conveyance between pages, and the cutting position determined by the selected configuration candidate.

2. The recording control device described in claim 1, wherein the recording control unit records images on the recording medium for each job containing one or a plurality of pages by means of the recording device.

3. The recording control device described in claim 2, wherein the input unit enables inputting information specifying whether or not to advance the recording medium between jobs by means of the transportation unit, and whether or not to cut the recording medium between jobs by means of the cutting unit, in addition to whether or not to advance the recording medium between pages by means of the transportation unit, and whether or not to cut the recording medium between pages by means of the cutting unit.

4. The recording control device described in claim 3, wherein the display control unit enables selecting configuration candidates indicating combinations of conveying or not conveying the recording medium between jobs, cutting or not cutting the recording medium between jobs, conveying or not conveying the recording medium between pages, and cutting or not cutting the recording medium between pages in the selection display unit when there is input from the input unit, and
when a configuration candidate is selected, displays an image showing the relationship between the image recorded on each page included in a job, the margins formed by conveying the recording medium between pages, the margins formed by conveying the recording medium between jobs, and the cutting positions based on the selected configuration candidate.

5. The recording control device described in claim 4, wherein:
the input unit enables inputting information specifying the recording direction of images on the recording medium and the type of recording medium; and
the display control unit displays for selection only the configuration candidates corresponding to the image recording direction and recording medium type set in the selection display unit when the image recording direction and recording medium type are set in the input unit.

6. The recording control device described in claim 5, wherein:
the display control unit changes and displays an image corresponding to the configuration candidate when a configuration candidate is selected in the selection display unit and a different configuration candidate is then selected by the input unit.

7. The recording control device described in claim 6, wherein:
the setting unit saves the information denoting the selected configuration candidate when a configuration candidate in the selection display unit is selected and then confirmed by the input unit.

8. A recording control method for controlling a recording device having a transportation means that conveys a recording medium, a recording means that records images on the recording medium, and a cutting means that cuts the recording medium, the recording control method comprising steps of:
displaying in a display screen for selection and input configuration candidates showing combinations of conveying and not conveying the recording medium between pages and cutting or not cutting the recording medium between pages when information specifying whether or not to advance the recording medium between pages by means of the transportation means, and whether or not to cut the recording medium between pages by means of the cutting means, is input, and displaying an image showing the relative positions of the images recorded on the pages, the margin formed by conveyance between pages, and the cutting position determined by the selected configuration candidate; and
setting the operation of the recording device based on the input information and causing the recording device to operate according to the set operation.

9. The recording control method described in claim 8, further comprising steps of:
recording images on the recording medium for each job containing one or a plurality of pages by means of the recording device;
enabling inputting information specifying whether or not to advance the recording medium between jobs by means of the transportation means, and whether or not to cut the recording medium between jobs by means of the cutting means, in addition to whether or not to advance the recording medium between pages by means of the transportation means, and whether or not to cut the recording medium between pages by means of the cutting means;
displaying in the display means for selection and input configuration candidates indicating combinations of conveying or not conveying the recording medium between jobs, cutting or not cutting the recording medium between jobs, conveying or not conveying the recording medium between pages, and cutting or not cutting the recording medium between pages when there is input; and
when a configuration candidate is selected, displaying an image showing the relationship between the image recorded on each page included in a job, the margins formed by conveying the recording medium between pages, the margins formed by conveying the recording medium between jobs, and the cutting positions based on the selected configuration candidate.

10. The recording control method described in claim 9, wherein:
information specifying the recording direction of images on the recording medium and the type of recording medium can be input; and
displaying in the display means for selection only the configuration candidates corresponding to the image recording direction and recording medium type that are set when a configuration is set.

11. The recording control method described in claim 10, wherein:
the image corresponding to the configuration candidate is changed and displayed when a configuration candidate is selected in the display means and a different configuration candidate is then selected; and
the information denoting the selected configuration candidate is saved when a configuration candidate is selected and then confirmed.

12. A program that can be executed by a computer for controlling a recording device having a transportation means that conveys a recording medium, a recording means that records images on the recording medium, and a cutting means that cuts the recording medium, the program causing the computer to operate as:
an input means that enables inputting information specifying whether or not to advance the recording medium between pages by means of the transportation means, and whether or not to cut the recording medium between pages by means of the cutting means;
a setting means that configures operation of the recording device based on the information input by means of the input means;
a recording control means that causes the recording device to operate according to the operation set by the setting means; and
a display control means that selectably presents in a display screen configuration candidates showing combinations of conveying and not conveying the recording medium between pages and cutting or not cutting the recording medium between pages when there is input from the input means, and
when a configuration candidate is selected by the input means, displays an image showing the relative positions of the images recorded on the pages, the margin formed by conveyance between pages, and the cutting position determined by the selected configuration candidate.
